(19) United States
(12) Patent Application Publication
(10) Pub. No.: US 2024/0066545 A1
(43) Pub. Date: Feb. 29, 2024

(54) APPLICATION MECHANISM AND APPLICATION APPARATUS

(71) Applicant: NTN Corporation, Osaka (JP)

(72) Inventor: Akihiro YAMANAKA, Iwata-shi, Shizuoka (JP)

(21) Appl. No.: 18/263,738

(22) PCT Filed: Feb. 24, 2022
(86) PCT No.: PCT/JP2022/007603

§ 371 Date: Aug. 1, 2023

(30) Foreign Application Priority Data
Feb. 25, 2021 (JP) 2021-028734

(51) Int. Cl. B05C 1/02

(52) U.S. Cl. CPC B05C 1/025

(57) ABSTRACT

An application mechanism applies a liquid material on an application surface. The application mechanism includes: an application needle holder fixing unit; an application needle holder detachably attached to the application needle holder fixing unit; an application needle held at the application needle holder; and a cushioning mechanism. The cushioning mechanism is capable of cushioning an impact when the application needle is brought into contact with the application surface.

### TECHNICAL FIELD

The present invention relates to an application apparatus and an application mechanism.

### BACKGROUND ART

An application mechanism described in Japanese Patent Laying-Open No. 2018-20325 (PTL 1) has an application needle holder fixing unit, an application needle holder, and an application needle. The application needle holder is attached to the application needle holder fixing unit. The application needle is held at the application needle holder. The application mechanism described in PTL 1 does not have a mechanism for cushioning an impact when the application needle is brought into contact with an application surface.

Meanwhile, an application mechanism described in Japanese Patent Laying-Open No. 2015-112577 (PTL 2) has an application needle holder, an application needle fixing plate, and an application needle. The application needle holder is attached to a movable base. The application needle is held at the application needle fixing plate. The application needle holder accommodates a spring and a linear guide. The linear guide holds the application needle so as to be slidable in a direction orthogonal to the application surface. The spring biases the application needle toward the application surface. Thus, an impact when the application needle is brought into contact with the application surface is cushioned.

### CITATION LIST

### Patent Literature

PTL 1: Japanese Patent Laying-Open No. 2018-20325
PTL 2: Japanese Patent Laying-Open No. 2015-112577

### SUMMARY OF INVENTION

### Technical Problem

When the application mechanism described in PTL 2 is applied to a purpose of use that requires strict management for contamination such as a diagnosis tip for extracorporeal diagnosis of diseases, it may be required to configure the application needle holder and the application needle to be disposable or sterilize the application needle holder and the application needle.

In the application mechanism described in PTL 2, since the spring and the linear guide are incorporated in the application needle holder to cushion the impact when the application needle is brought into contact with the application surface, manufacturing cost is increased when the application needle holder and the application needle are configured to be disposable. Further, in the application mechanism described in PTL 2, since the linear guide is incorporated in the application needle holder and the application needle is fixed to the application needle fixing plate by an adhesive agent, it is difficult to sterilize the application needle holder and the application needle in the application mechanism described in PTL 2.

The present invention has been made in view of the above-described problem of the conventional art. More specifically, the present invention provides an application mechanism and an application apparatus, by each of which an impact when an application needle is brought into contact with an application surface can be cushioned without increasing manufacturing cost even when an application needle holder and the application needle need to be disposable or the application needle holder and the application needle need to be sterilized.

### Solution to Problem

An application mechanism of the present invention applies a liquid material on an application surface. The application mechanism includes: an application needle holder fixing unit; an application needle holder detachably attached to the application needle holder fixing unit; an application needle held at the application needle holder; and a cushioning mechanism. The cushioning mechanism is capable of cushioning an impact when the application needle is brought into contact with the application surface.

In the application mechanism, the application mechanism may have a linear guide and an elastic member. The application needle holder fixing unit may be held at the linear guide so as to be slidable in a direction orthogonal to the application surface. The elastic member may bias the application needle holder fixing unit toward the application surface.

The application mechanism may further include: a first magnet held at the application needle holder fixing unit; and a second magnet held at the application needle holder. The application needle holder may be composed of a resin material. The application needle holder may be detachably attached to the application needle holder fixing unit by the second magnet being attracted to the first magnet.

The application mechanism may further include: a first magnet attached to the application needle holder fixing unit; and a second magnet held at the application needle holder. The application needle holder may be composed of a non-magnetic metal material. The application needle holder may be detachably attached to the application needle holder fixing unit by the second magnet being attracted to the first magnet.

An application mechanism of the present invention includes the above-described application mechanism.

### Advantageous Effects of Invention

According to each of the application mechanism and the application apparatus of the present invention, an impact when the application needle is brought into contact with the application surface can be cushioned without increasing manufacturing cost even when the application needle holder and the application needle need to be disposable or the application needle holder and the application needle need to be sterilized.

### BRIEF DESCRIPTION OF DRAWINGS

FIG. 1 is a perspective view of an application mechanism 10 with an application needle holder 12, an application needle 13, and a container 15 being not illustrated.

FIG. 2 is a side view of application mechanism 10 with application needle holder 12, application needle 13, and container 15 being not illustrated.

FIG. 3 is a perspective view of application needle holder 12 and application needle 13 included in application mechanism 10.

FIG. 4 is a side view of application needle holder 12 and application needle 13 included in application mechanism 10.

FIG. 5 is a perspective view of application mechanism 10.

FIG. 6 is a front view of an application needle holder 12 and an application needle 13 included in an application mechanism 10A.

FIG. 7 is a rear view of application needle holder 12 and application needle 13 included in application mechanism 10A.

FIG. 8 is a side view of application needle holder 12 and application needle 13 included in application mechanism 10A.

FIG. 9 is a perspective view of application apparatus 100.

### DESCRIPTION OF EMBODIMENTS

Embodiments of the present invention will be described in detail with reference to figures. In the following figures, the same or corresponding parts are denoted by the same reference characters, and the same explanation will not be described repeatedly.

### First Embodiment

An application mechanism (hereinafter referred to as “application mechanism 10”) according to a first embodiment will be described.

<Configuration of Application Mechanism 10>

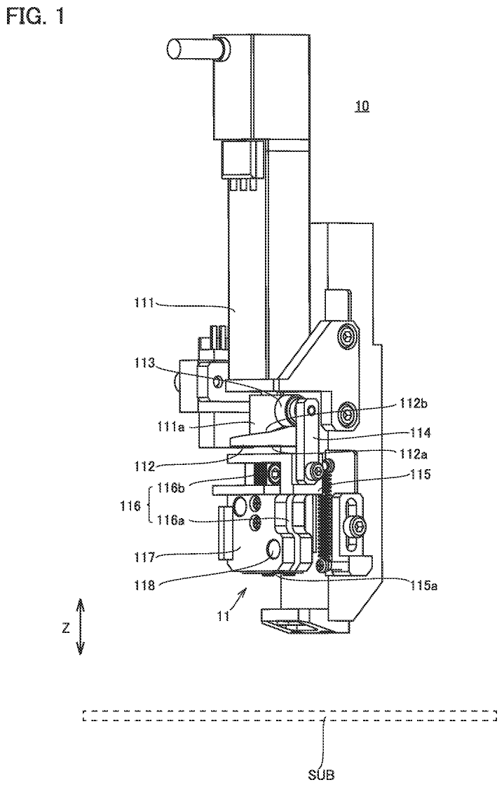

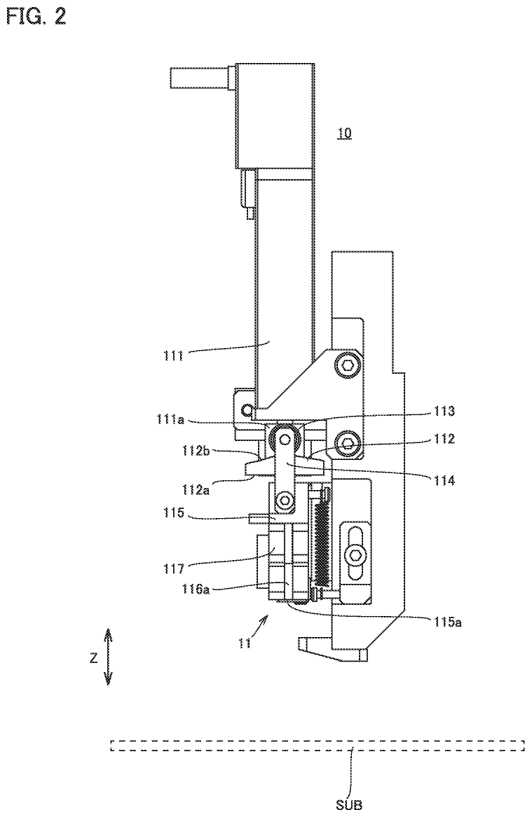

FIG. 1 is a perspective view of application mechanism 10 with an application needle holder 12, an application needle 13, and a container 15 being not illustrated. FIG. 2 is a side view of application mechanism 10 with application needle holder 12, application needle 13, and container 15 being not illustrated. As shown in FIGS. 1 and 2, application mechanism 10 has a driving mechanism 11.

Driving mechanism 11 has, for example, a servo motor 111, a cam 112, a bearing 113, a cam coupling plate 114, a movable portion 115, a cushioning mechanism 116, an application needle holder fixing unit 117, and a first magnet 118.

Servo motor 111 has a rotation shaft 111a. Rotation shaft 111a extends along a Z axis. The Z axis is orthogonal to an application surface of a substrate SUB. Although not shown, servo motor 111 is connected to an electrical-component box 27 described later. Servo motor 111 rotates rotation shaft 111a around a center axis. Cam 112 has a first surface 112a and a second surface 112b. First surface 112a faces downward. Second surface 112b faces upward. That is, second surface 112b is a surface opposite to first surface 112a.

Second surface 112b has a central portion and an outer peripheral portion. The outer peripheral portion of second surface 112b is located around the central portion of second surface 112b. Cam 112 is attached to rotation shaft 111a at the central portion of second surface 112b. A distance between second surface 112b and first surface 112a is varied along a peripheral direction (a direction along a circumference centered on the center axis of rotation shaft 111a). Second surface 112b is a cam surface of cam 112.

Bearing 113 is disposed such that the outer peripheral surface of bearing 113 is in contact with the cam surface (second surface 112b) of cam 112. Cam coupling plate 114 is coupled to bearing 113 at one end and is coupled to movable portion 115 at the other end.

Cushioning mechanism 116 is attached to movable portion 115. Cushioning mechanism 116 has, for example, a linear guide 116a and an elastic member 116b. Linear guide 116a is attached to movable portion 115. Application needle holder fixing unit 117 is held by linear guide 116a so as to be slidable in the Z axis direction.

Elastic member 116b is, for example, a coil spring. Elastic member 116b biases application needle holder fixing unit 117 toward the application surface of substrate SUB. More specifically, elastic member 116b presses application needle holder fixing unit 117 against a stopper 115a provided at movable portion 115. First magnet 118 is held at application needle holder fixing unit 117.

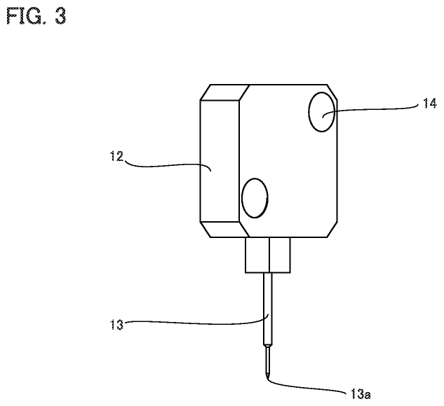

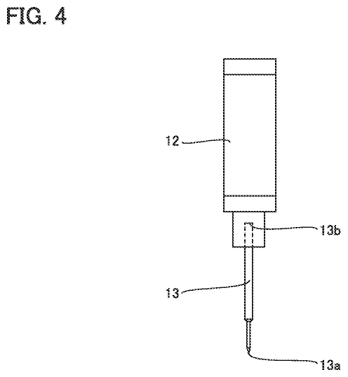

FIG. 3 is a perspective view of application needle holder 12 and application needle 13 included in application mechanism 10. FIG. 4 is a side view of application needle holder 12 and application needle 13 included in application mechanism 10. As shown in FIGS. 3 and 4, application mechanism 10 further has application needle holder 12 and application needle 13. Application needle 13 has a distal end 13a and a proximal end 13b. Proximal end 13b is an end opposite to distal end 13a in a longitudinal direction of application needle 13. The longitudinal direction of application needle 13 is along the Z axis direction.

Application needle 13 is held by application needle holder 12. More specifically, application needle 13 is held at application needle holder 12 with the proximal end 13b side of application needle 13 being embedded in application needle holder 12. Application mechanism 10 further has a second magnet 14.

Application needle holder 12 is composed of a resin material. Application needle 13 and second magnet 14 are held at application needle holder 12 with application needle 13 and second magnet 14 being insert-molded together with the resin material of application needle holder 12, for example. That is, application needle holder 12 does not have: a linear guide that holds application needle 13 so as to be slidable in the Z axis direction; and an elastic member that biases application needle 13 toward the application surface of substrate SUB.

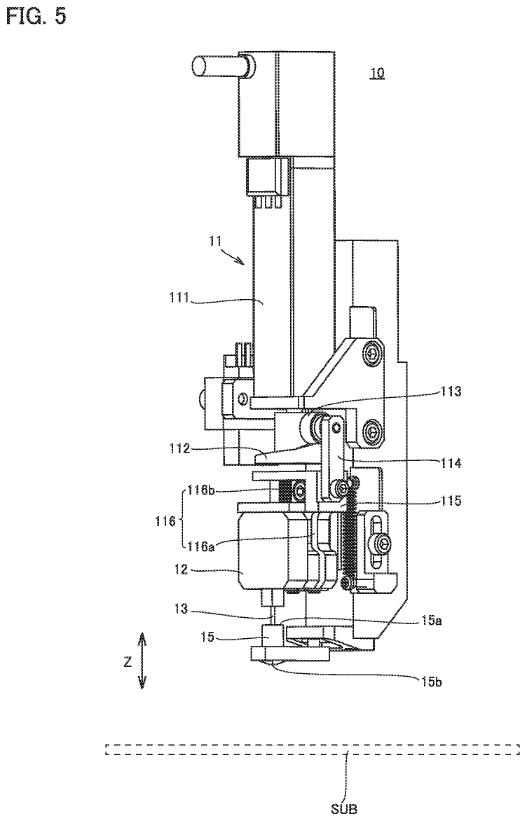

Second magnet 14 is held at application needle holder 12. FIG. 5 is a perspective view of application mechanism 10. As shown in FIG. 5, application needle holder 12 is detachably attached to application needle holder fixing unit 117. More specifically, application needle holder 12 is detachably attached to application needle holder fixing unit 117 by second magnet 14 being attracted to first magnet 118.

Application mechanism 10 further has a container 15. Container 15 has an upper end 15a and a lower end 15b. Lower end 15b is an end opposite to upper end 15a. Container 15 is hollow. Container 15 is opened at upper end 15a. Lower end 15b is closed by a bottom wall provided with a through hole. A liquid material is stored in an inner space of container 15. Distal end 13a is inserted into the inner space of container 15 from the opening of upper end 15a.

As rotation shall 111a is rotated, cam 112 is rotated. Since the distance between second surface 112b and first surface 112a is varied, the rotation of cam 112 varies the position of bearing 113 in the Z axis direction.

As described above, movable portion 115 is coupled to bearing 113 by cam coupling plate 114, and application needle holder fixing unit 117 is attached to movable portion 115. Further, application needle holder 12 is attached to application needle holder fixing unit 117. Therefore, when the position of bearing 113 in the Z axis direction is varied, the position of application needle 13 held by application needle holder 12 in the Z axis direction is varied. In this way, driving mechanism 11 moves the position of application needle 13 (distal end 13a) in the Z axis direction.

When driving mechanism 11 moves application needle 13 to protrude distal end 13a from the through hole formed in the bottom wall that closes lower end 15b of container 15, the liquid material in container 15 is adhered to distal end 13a.

<Effects of Application Mechanism 10>

In application mechanism 10, since application needle holder fixing unit 117 is held by linear guide 116a so as to be slidable in the Z axis direction and elastic member 116b biases application needle holder fixing unit 117 toward the application surface of substrate SUB, application needle 13 is moved away from the application surface of substrate SUB along the Z axis direction when application needle 13 is brought into contact with the application surface of substrate SUB, thereby cushioning the impact when application needle 13 is brought into contact with the application surface of substrate SUB.

Further, in application mechanism 10, since application needle holder 12 is composed of the resin material and does not have a linear guide and an elastic member that cushion an impact when application needle 13 is brought into contact with the application surface of substrate SUB, an increase in manufacturing cost can be suppressed even when application needle holder 12 and application needle 13 are configured to be disposable.

### Second Embodiment

An application mechanism (hereinafter referred to as “application mechanism 10A”) according to a second embodiment will be described. Here, differences from application mechanism 10 will be mainly described, and the same explanation will not be described repeatedly.

Application mechanism 10A has a driving mechanism 11, an application needle holder 12, an application needle 13, a second magnet 14, and a container 15. In this respect, application mechanism 10A is the same as application mechanism 10. However, application mechanism 10A differs from application mechanism 10 in terms of a detailed configuration of application needle holder 12.

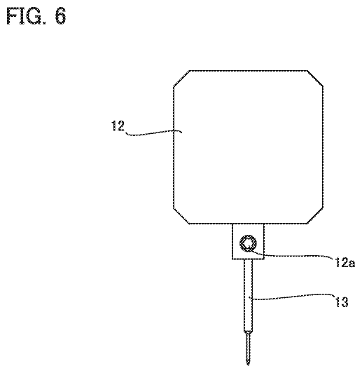

FIG. 6 is a front view of application needle holder 12 and application needle 13 included in application mechanism 10A. As shown in FIG. 6, application needle 13 is held by application needle holder 12 on the proximal end 13b side. More specifically, application needle 13 is held at application needle holder 12 by a screw 12a. Application needle holder 12 is composed of a non-magnetic metal material. A specific example of the non-magnetic metal material is aluminum or an aluminum alloy.

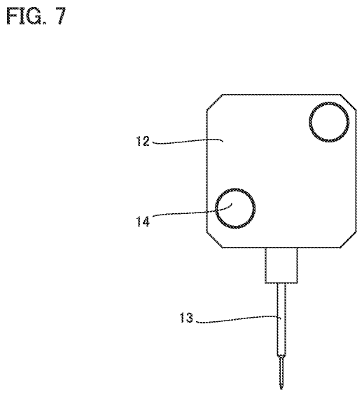

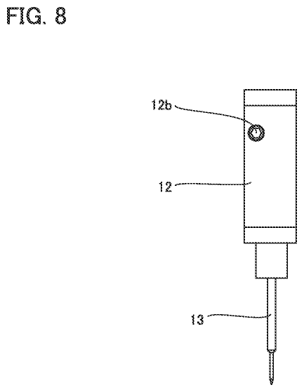

FIG. 7 is a rear view of application needle holder 12 and application needle 13 included in application mechanism 10A. FIG. 8 is a side view of application needle holder 12 and application needle 13 included in application mechanism 10A. As shown in FIGS. 7 and 8, second magnet 14 is held at application needle holder 12. More specifically, second magnet 14 is held at application needle holder 12 by a screw 12b. It should be noted that in application mechanism 10A, application needle holder 12 does not have: a linear guide that holds application needle 13 so as to be slidable in the Z axis direction; and an elastic member that biases application needle 13 toward the application surface of substrate SUB.

Since application mechanism 10A has cushioning mechanism 116 as with application mechanism 10, an impact when application needle 13 is brought into contact with the application surface of substrate SUB can be cushioned. In order to sterilize application needle holder 12 and application needle 13, application needle holder 12 and application needle 13 needs to be held under a high-temperature environment. In application mechanism 10A, since application needle 13 is fixed by screw 12a, application needle holder 12 has no portion adhered by an adhesive agent. Further, in application mechanism 10A, application needle holder 12 is composed of a metal material having a heat resistance. Therefore, in application mechanism 10A, since application needle holder 12 and application needle 13 can be sterilized under the high-temperature environment and therefore can be reused, an increase in manufacturing cost can be suppressed.

### Third Embodiment

An application apparatus (hereinafter referred to as “application apparatus 100”) according to a third embodiment will be described.

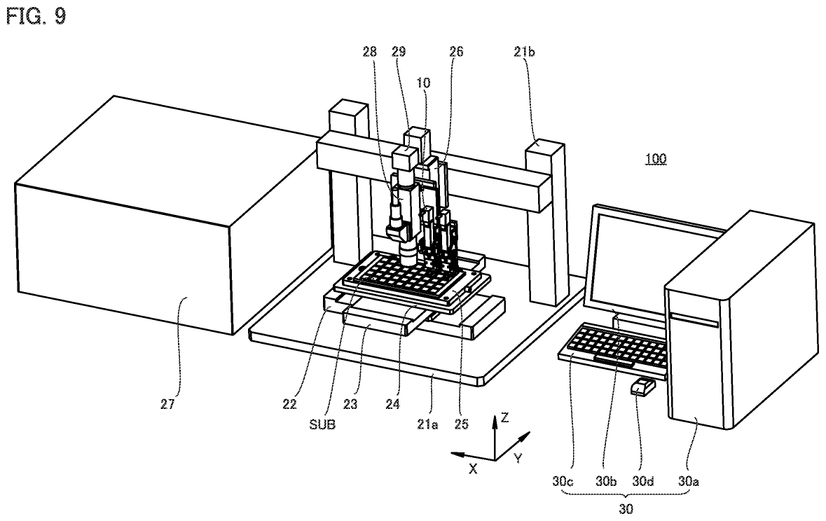

FIG. 9 is a perspective view of application apparatus 100. As shown in FIG. 9, application apparatus 100 has application mechanism 10, a base plate 21a and a frame 21b, an X axis stage 22, a Y axis stage 23, a stage movable plate 24, an attraction plate 25, a Z axis stage 26, an electrical-component box 27, an observation optical system 28, an image capturing device 29, and a controller 30.

X axis stage 22 is disposed on base plate 21a. X axis stage 22 has a movable portion, and the movable portion is moved along the X axis direction. Frame 21b is attached to base plate 21a. Y axis stage 23 is disposed on the movable portion of X axis stage 22. Y axis stage 23 has a movable portion, and the movable portion is moved along the Y axis direction. It should be noted that the Y axis is orthogonal to the X axis.

Stage movable plate 24 is disposed on the movable portion of Y axis stage 23. Attraction plate 25 is disposed on stage movable plate 24. Substrate SUB is disposed on attraction plate 25. The position of substrate SUB is fixed with substrate SUB being attracted to attraction plate 25. By moving the movable portion of X axis stage 22 and the movable portion of Y axis stage 23, the position of substrate SUB in directions along the X axis and the Y axis is changed.

Z axis stage 26 is attached to frame 21b. Z axis stage 26 has a movable portion, and the movable portion is moved along the Z axis. It should be noted that the Z axis is orthogonal to the X axis and the Y axis and corresponds to a vertical direction. Further, the Z axis is orthogonal to a main surface of substrate SUB.

Application mechanism 10 is attached to the movable portion of Z axis stage 26. By moving the movable portion of Z axis stage 26, the position of application mechanism 10 in the Z axis direction is changed. Image capturing device 29 can observe substrate SUB via observation optical system 28. Image capturing device 29 is, for example, a CCD (Charge Coupled Device) camera.

Electrical-component box 27 is connected to X axis stage 22, Y axis stage 23, Z axis stage 26, and application mechanism 10. Electrical components for driving X axis stage 22, Y axis stage 23, Z axis stage 26, and application mechanism 10 are stored in electrical-component box 27.

Controller 30 has, for example, a computer 30a, a monitor 30b, a keyboard 30c, and a mouse 30d.

Computer 30a is, for example, a personal computer. Computer 30a is connected to electrical-component box 27 (more specifically, each electrical component stored in electrical-component box 27), and sends, to electrical-component box 27, a control signal for driving X axis stage 22, Y axis stage 23, Z axis stage 26, and application mechanism 10.

Monitor 30b is connected to computer 30a. An image captured by image capturing device 29 and an operation screen of computer 30a are displayed on monitor 30b. Keyboard 30c and mouse 30d are connected to computer 30a. Various types of inputs are performed using keyboard 30c and mouse 30d on the operation screen displayed on monitor 30b, thereby sending a control signal from computer 30a to electrical-component box 27.

For application of a liquid material onto substrate SUB, controller 30 first drives X axis stage 22 and Y axis stage 23 via electrical-component box 27 so as to position an application-target position of substrate SUB immediately below observation optical system 28.

Next, the application-target position of substrate SUB is observed and confirmed by observation optical system 28 and image capturing device 29, and the application-target position of substrate SUB is determined based on a result of the observation and confirmation. Further, Z axis stage 26 and application mechanism 10 (driving mechanism 11) are driven based on an application command input to controller 30 via keyboard 30c and mouse 30d.

As a result, distal end 13a having the liquid material adhered thereon protrudes from the through hole formed in the bottom wall that closes lower end 15b of container 15, and the liquid material is brought into contact with the application surface of substrate SUB, thereby applying the liquid material on substrate SUB.

Although the embodiments of the present invention have been illustrated, the embodiments described above can be modified in various manners. Further, the scope of the present invention is not limited to the above-described embodiments. The scope of the present invention is defined by the terms of the claims, and is intended to include any modifications within the scope and meaning equivalent to the terms of the claims.

### INDUSTRIAL APPLICABILITY

Each of the above-described embodiments is particularly advantageously applied to an application mechanism and an application device for a liquid material.

### REFERENCE SIGNS LIST

10: application mechanism; 10A: application mechanism; 11: driving mechanism; 12: application needle holder; 12a: screw; 12b: screw; 13: application needle; 13a: distal end; 13b: proximal end; 14: second magnet; 15: container; 15a: upper end; 15b: lower end; 21a: base plate; 21b: frame; 22: X axis stage; 23: Y axis stage; 24: stage movable plate; 25: attraction plate; 27: electrical-component box; 28: observation optical system; 29: image capturing device; 30: controller; 30a: computer; 30b: monitor; 30c: keyboard; 30d: mouse; 100: application device; 111: servo motor; 111a: rotation shaft; 112: cam; 112a: first surface; 112b: second surface; 113: bearing; 114: cam coupling plate; 115: movable portion; 115a: stopper; 116: cushioning mechanism; 116a: linear guide; 116b: elastic member; 117: application needle holder fixing unit; 118: first magnet; SUB: substrate.

1. An application mechanism that applies a liquid material on an application surface, the application mechanism comprising:
an application needle holder fixing unit;
an application needle holder detachably attached to the application needle holder fixing unit;
an application needle held at the application needle holder; and
a cushioning mechanism, wherein
the cushioning mechanism is capable of cushioning an impact when the application needle is brought into contact with the application surface.

2. The application mechanism according to claim 1, wherein
the application mechanism has a linear guide and an elastic member,
the application needle holder fixing unit is held at the linear guide so as to be slidable in a direction orthogonal to the application surface, and
the elastic member biases the application needle holder fixing unit toward the application surface.

3. The application mechanism according to claim 1, further comprising:
a first magnet held at the application needle holder fixing unit; and
a second magnet held at the application needle holder, wherein
the application needle holder is composed of a resin material, and
the application needle holder is detachably attached to the application needle holder fixing unit by the second magnet being attracted to the first magnet.

4. The application mechanism according to claim 1, further comprising:
a first magnet held at the application needle holder fixing unit; and
a second magnet held at the application needle holder, wherein
the application needle holder is composed of a non-magnetic metal material, and
the application needle holder is detachably attached to the application needle holder fixing unit by the second magnet being attracted to the first magnet.

5. An application apparatus comprising the application mechanism according to claim 1.
